(19) United States
(12) Patent Application Publication
(10) Pub. No.: US 2005/0229015 A1
(43) Pub. Date: Oct. 13, 2005

(54) Method for controlling the mode of an electronic application

(75) Inventors: Frank J. P. Van Rens, Eindhoven (NL); Johannes Misdom, Eindhoven (NL); Juergen Kordts, Buxtehude (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., 5621 BA Eindhoven (NL)

(21) Appl. No.: 10/505,836

(22) PCT Filed: Feb. 3, 2003
(86) PCT No.: PCT/IB03/00370

§ 371 Date: Aug. 25, 2004

(30) Foreign Application Priority Data
Feb. 28, 2002 (EP) 02075807.4

(51) Int. Cl. G06F 1/26

(52) U.S. Cl. 713/300

(57) ABSTRACT

Method for controlling the mode of an electronic application like audio systems, display systems or portable equipment. The output stage of the electronic application controls the modes of the system, for example a normal mode, a standby mode or a sleep mode. The inventive method uses the existing connections for the input signals of the output stage. The allover level of the input signal or signals is divided into several ranges. One of the ranges is the normal operation range and the others who lay above or under the normal range are the extended ranges. The different ranges can be of different levels. The input signal can be a time, frequency, current or voltage. The inventive electronic application can be configured as a single-ended input as a differential input or as a multiple input.

### FIELD OF E INVENTION

The invention relates to a method for controlling the mode of an electronic application, especially to the power management of output stages. These output stages are for example part of consumer electronics like audio systems, display systems or portable equipment. The driver stage controls the output stage and thus the modes of the system, for example a normal mode, a standby mode or a sleep mode.

### BACKGROUND OF THE INVENTION

A conventional power management output power stage is part of a power stage IC. An input of the power stage IC is used to control the standby mode and/or other modes. In the conventional power management the connection from the driver IC to the power stage IC is made by means of a separate control connection. The disadvantage of the conventional power management is that one or more extra pins are needed.

Another conventional power management uses a digital control bus. In this case the power management is executed by means of a control bus. The disadvantage of this system is that two extra pins are needed on the output power stage IC, that the output device has to be equipped with a digital interface and that the bus translator requires space within the output power stage IC.

U.S. Pat. No. 5,230,055 discloses a battery operated personal computer including ambient temperature and humidity sensors. If the temperature and/or the humidity exceed the limits, the computer enters a low power suspend mode wherein the computer is inoperable. This US-Patent does not give any details on how the halt is executed. The only way to recover from halt is to reboot the computer.

### SUMMARY OF THE INVENTION

Therefore, an object of the invention is to provide a power management for output stages that does not demand extra pins or a separate interface connection.

This problem is solved by using the one or two existing connections between the driver IC and the output power stage IC for transferring supplementary to the normal operating signals further signals concerning the possible modes. Different types of modes are executed by using different input ranges for the output power stage IC.

The inventive total input range is divided into a normal one and into an extended one. Input signals that are in the normal operating range refer for example to operations like amplify or switch. Input signals that are not within the normal operating range but are within the extended input range are used for mode recognition, e.g. standby mode, low EMI mode, measuring mode or configuration mode, with EMI standing for electromagnetic interference and low EMI mode is, for example, achieved by reducing the rise and fall time in a video amplifier.

The above-mentioned range can be a voltage range, a current range, a frequency range or a time range for example. Each range is defined by a minimum and a maximum (input) value. The ranges may be of different sizes.

The inventive power management of output stages meets the market's trend of going low power and low costs. This means for many devices that they must have some power saving features with minimum costs. The consequence for manufacturers of electronic devices is that for example integrated circuits must have a power saving mode or multiple power saving modes. The realization that input value ranges beyond the normal range can be used for starting the power saving mode leads to the idea of dividing the extended operating range into differently divided ranges which stand for different modes like standby mode, low EMI-mode, measuring mode or configuration mode. Of course the value of each range has to meet with the resolution of the whole system.

In common electric devices the output stage is driven only by input signal(s) corresponding to the normal operating mode, for example amplifying or switching. The invention is based on extending the possibilities for the meaning of the input signals of the output stage. There are two ways for achieving the extension, one way is to extend the overall level, the other way is to divide the common overall level for input signals into more ranges each one of them with a smaller level than the additional. The extension of the input range can be above and/or below the common one.

There are two possible implementations for the input signal, the single input device and the multiple input device. With the single input device the number of modes depends on the number n of defined ranges.
max. number of modes=n (1)
With the multiple input device the maximum number of modes depends on the amount m of inputs.
max. number of modes=n^{m} (2)

### BRIEF DESCRIPTION OF THE DRAWINGS

The objects and the advantages of the present invention will become more readily apparent to those ordinarily skilled in the art after reviewing the following detailed description and accompanying drawings, wherein:

FIG. 1 shows the extended range definition;

FIG. 2 shows multiple ways of detection of modes;

FIG. 3 shows the differential range definition;

FIG. 4 shows a block diagram of device input with range detection;

FIG. 5 shows the varieties a) to f) of drivers with voltage output sources of dividers that can put the power stage into different modes;

FIG. 6 shows the varieties a) to g) of drivers with current output sources of dividers that can put the power stage into different modes;

FIG. 7 shows a block diagram for the determination of the input signal range;

FIG. 8 shows an example of input range detection by sensing voltage;

FIG. 9 shows a truth table for the mode selection for the example of a video booster;

FIG. 10 shows example values for the input current of a vertical booster;

FIG. 11 shows an example of a single ended input range definition by sensing current;

FIG. 12 shows the example of differential input range definition by sensing current;

FIG. 13 shows an example of a truth table of mode selection for a vertical booster with single ended detection;

FIG. 14 shows an example of a truth table for the mode selection of a vertical booster with differential detection;

FIG. 15 shows one example of a truth table for the mode selection of a vertical booster with differential offset detection;

FIG. 16 shows the implementation of a differential input detection as a mode selector;

FIG. 17 shows a single ended input range definition by sensing frequency;

FIG. 18 shows an example of a truth table for the mode selection with a frequency range;

FIG. 19 shows a single ended input range definition by sensing time;

FIG. 20 shows one example of a truth table for a mode selection for time range.

### DETAILED DESCRIPTION OF THE DRAWINGS

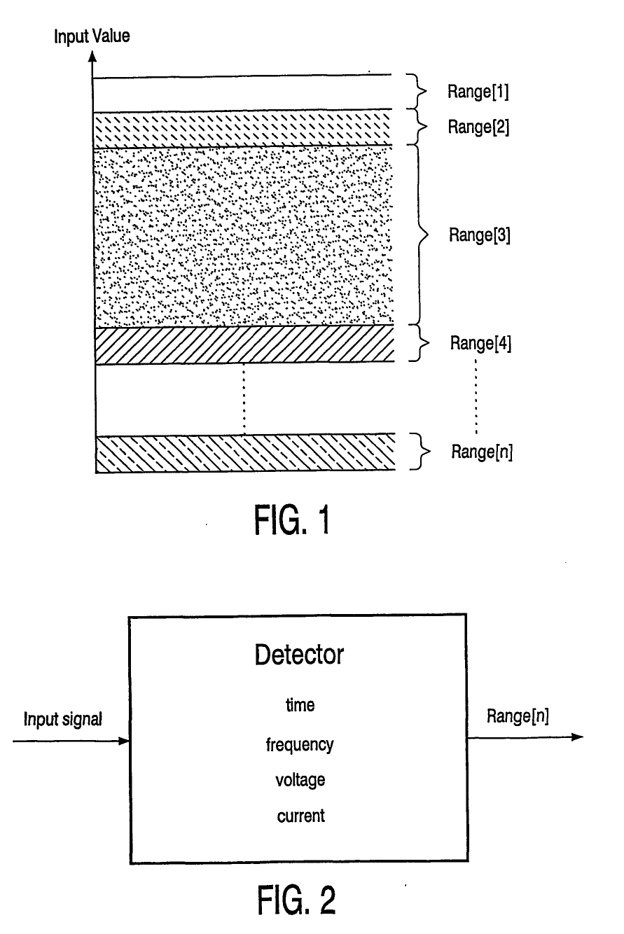

FIG. 1 shows the possibility of the definition of the extended range. The ranges can be of different sizes. The input value might go from zero to positive values or from negative values to positive values. In this Figure “n” stands for the number of defined ranges. Each range can stand for another mode. FIG. 1 shows a single-ended detection that means each input is measured separately and its value determines the range.

FIG. 2 shows that the detection of modes can be done by multiple ways. The various kinds of detection are for example time, frequency, voltage or current. The implementation of the mode detection can be related to different units.

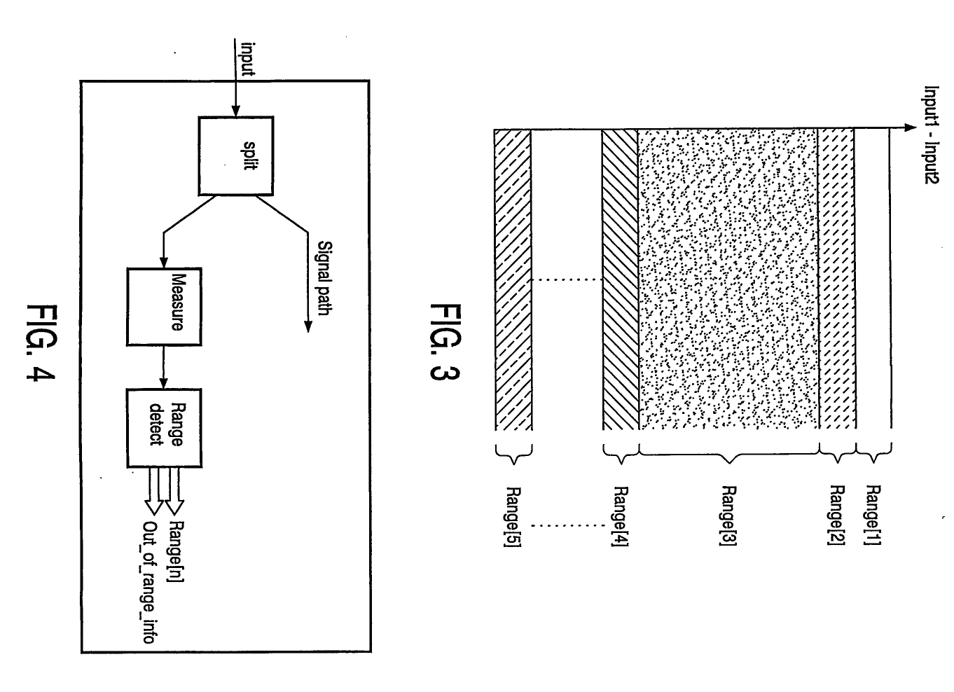

FIG. 3 shows the differential detection. This means that the difference between two inputs is measured and its value determines the range. The differential detection is especially significant for output stages that are driven with asymmetrical signals.

FIG. 4 shows a block diagram of the output stage with the range detection of the input. The input signal of the output stage enters a split where is determined whether the signal is within the normal operation range or the extended operating range. If it is within the normal operation range the input signal is lead to the normal signal path. If it is within the extended operating range it is lead to the detection path where it is measured. The result of the measurement is put into a range detection module, the range detection module causes the output stage to adjust the detected mode or creates an out of range info. The out of range info can also be used to set the output stage into stand-by.

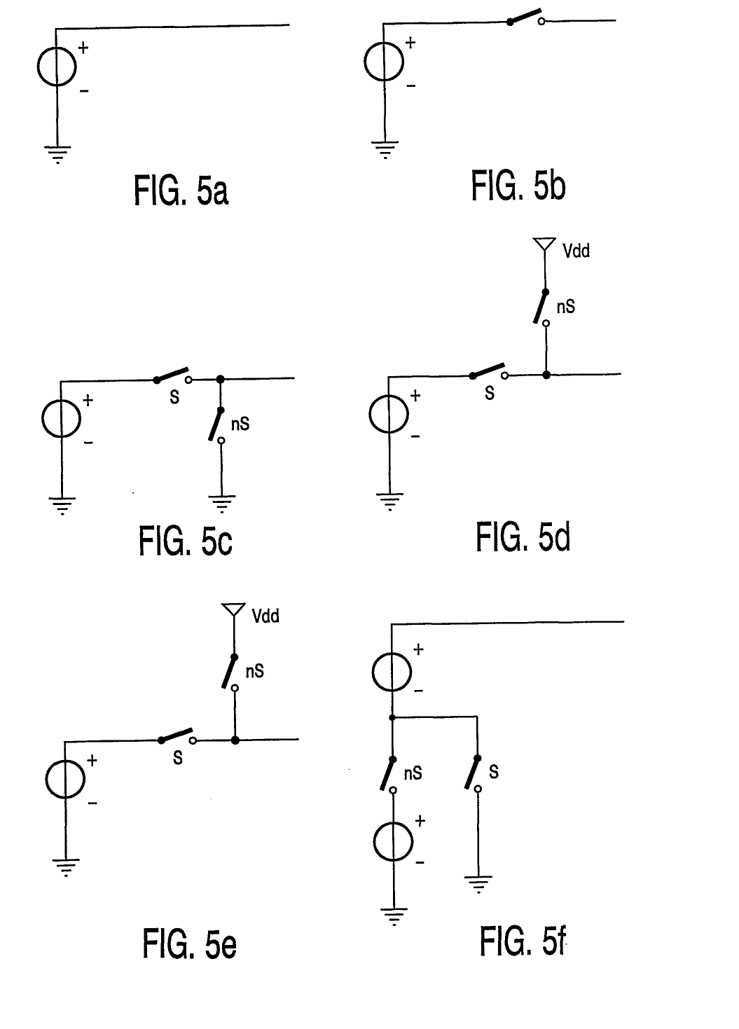

FIG. 5a) to f) show possible implementations for the mode selection by voltage output detection, for example the voltage output of a driver IC. The driver IC's output signal is the output stage's input signal.

FIG. 5a) shows the normal voltage output.

FIG. 5b) shows the voltage output with “high ohmic” switch. This configuration makes possible an easy detection at the receiver device and consists of only one switch that is mounted as a floating switch.

FIG. 5c) shows the voltage output with “short to ground” switch. This configuration makes also an easy detection at the output stage possible but consists already of two switches whereas one of the both is a floating switch and mounted as a break contact.

FIG. 5d) shows the voltage output with “short to supply” switch. This configuration is the same as in FIG. 5c).

FIG. 5e) shows the voltage output with “short to reference” switch. This configuration offers also an easy detection at the receiver device but requires a reference voltage. Two switches are necessary whereas one is mounted as a break contact.

FIG. 5f) shows the voltage output with “add voltage” switch. This configuration offers also an easy detection at the receiver device and supplementary the possibility of signal transfer in both situations. The disadvantage of this configuration is that a series connection of the voltage sources is needed and that two switches are required whereas one is a floating one and the other is mounted as a break contact.

In this Figures S stands for switch, nS stands for not switch (break contact), Vref stands for reference voltage and Vdd stands for supply voltage of the IC. The output signal of the described circuitries is the input signal of the electronic application, device or IC.

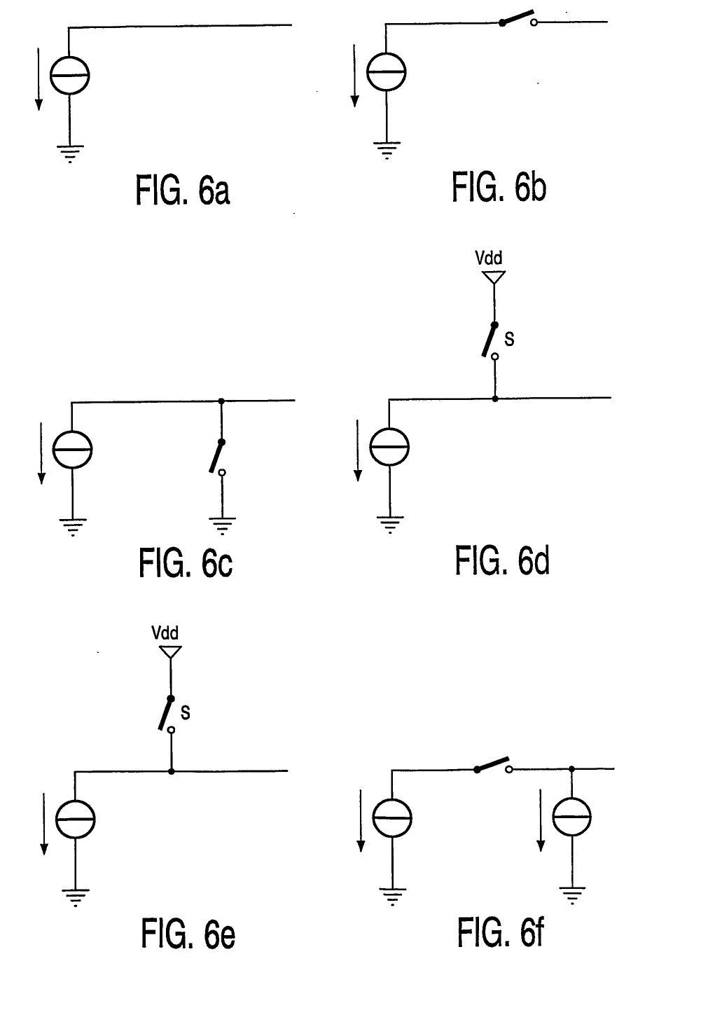

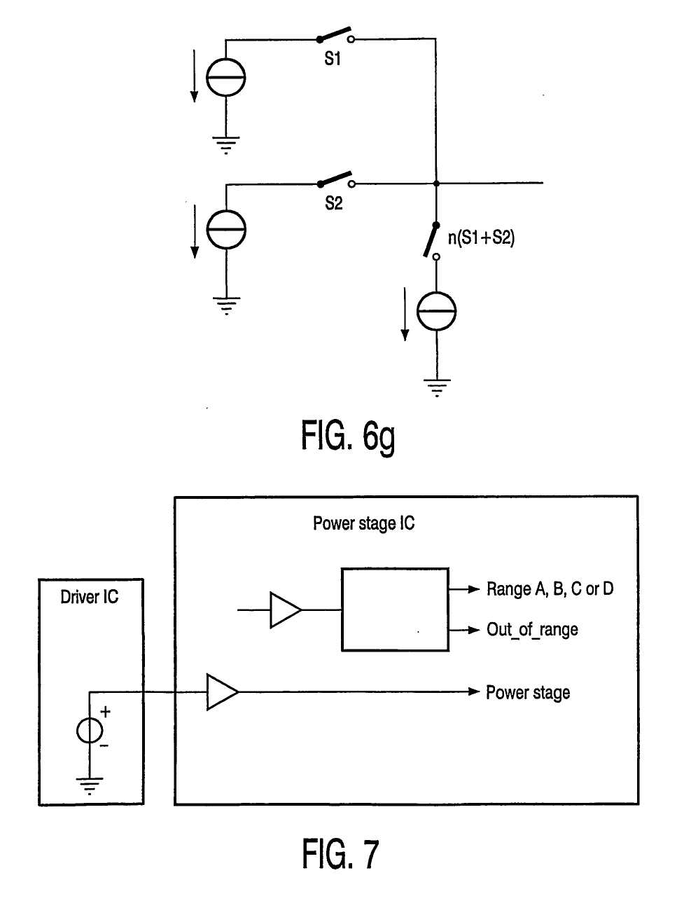

The FIGS. 6a) to 6g) show possible implementations for the mode selection by dividers with current output sources, for example the current output of a driver IC. The driver IC's output signal is the output stage's input signal.

FIG. 6a) shows a normal current output.

FIG. 6b) shows a current output that can be made floating with a switch. This configuration has the advantages of an easy detection at the receiver device and of only one switch needed. The disadvantage is that the single switch is a floating switch.

FIG. 6c) shows the current output with “short to ground” switch. This configuration offers the possibility of an easy detection at the receiver device.

FIG. 6d) shows the current output with “short to supply” switch. This configuration also offers the possibility of easy detection at the receiver device.

FIG. 6e) shows the current output with “short to reference” switch.

FIG. 6f) shows the current output with “add current” switch. This configuration offers the possibility of easy detection at the receiver device and of a signal transfer in both situations (switch=ON and switch=OFF). The disadvantages are that an extra current source is needed and that the switch is floating.

FIG. 6g) shows the current output with switch for multiple ranges. This configuration also offers the possibility of easy signal detection at the receiver device and supplementary to address multiple ranges. The disadvantages are that two extra current sources and three switches (one of them as a break contact) are needed and that the switches are floating.

The implementation of the part FIGS. 6a) to 6g) is also possible with current sink sources.

In the FIGS. 6a) to 6g) S stands for switch, nS stands for not switch (break contact), Vref stands for reference voltage, Vdd stands for supply voltage of the IC and Iref stands for reference current. The output signal of the described circuitries is the input signal of the electronic application.

In principle, every configuration can be used in each situation. Reason to prefer one configuration above another is, for example:
Compatibility: The inventive driver device or receiver device must be compatible with the older driver/receiver devices.
Marketing: For example, the inventive driver/receiver devices (ICs) must be sold as a chip-set and may not be compatible with ICs from other suppliers.
Costs: It is obvious that the configurations in FIG. 5 and FIG. 6 differ in their costs.
Costs: The configuration can also affect the costs of the output stage.

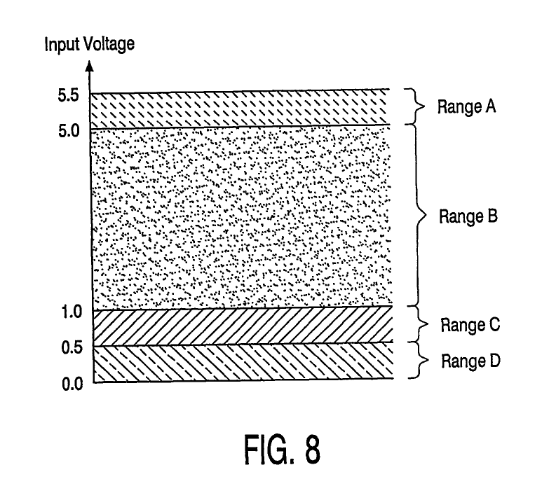

FIG. 7 shows a block diagram of another embodiment for the determination of the input signal range. In this embodiment a driver IC generates the input signal for the power stage IC. The input signal is lead to an amplifier and then branched. One branch lead to a power stage, the other branch leads via another amplifier to a detection module. The embodiment in FIG. 7 refers to the example of input range definition by sensing voltage shown in FIG. 8. Therefore, the result of the mode detection can be ranged A, B, C or D or out of range.

As mentioned above FIG. 8 shows an example of input range definition by sensing voltage. In this example the all over value for the input voltage goes from 0 to 5.5 volt. The all over level is divided into four ranges. Three of them are of the same size, that is 0.5 volt. The size of the fourth range (range B) is 4 volt.

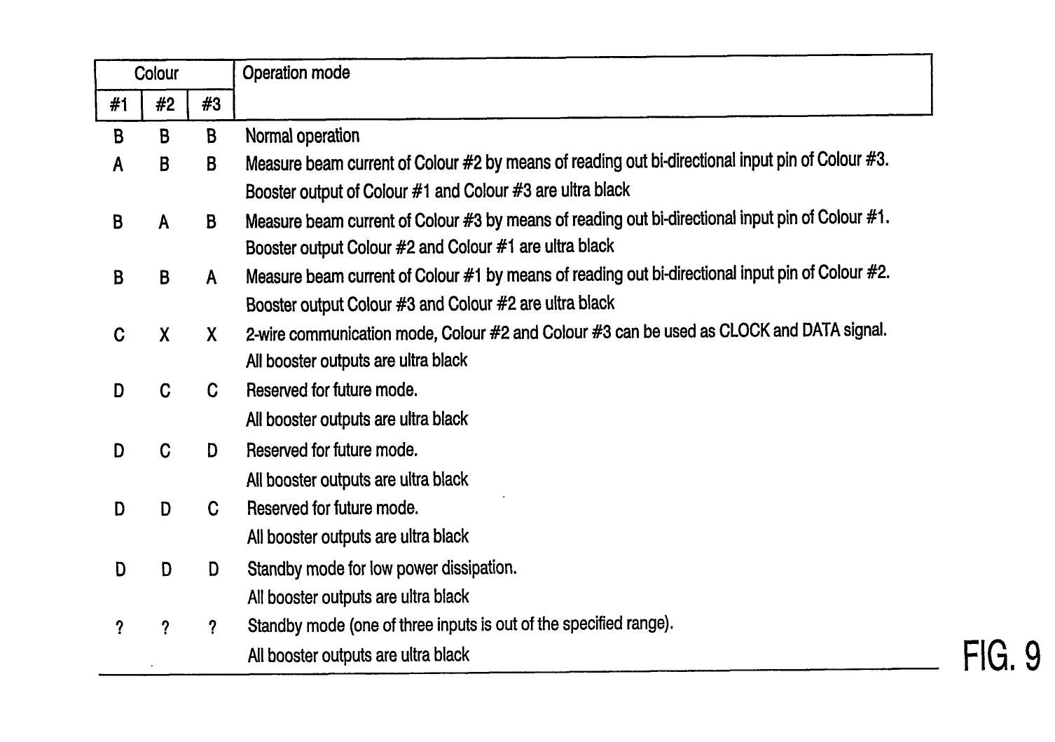

FIG. 9 shows the truth table for the mode selection of, for example, a video booster. The video booster has three inputs for the different colors. A number of combinations is explained in the truth-table.

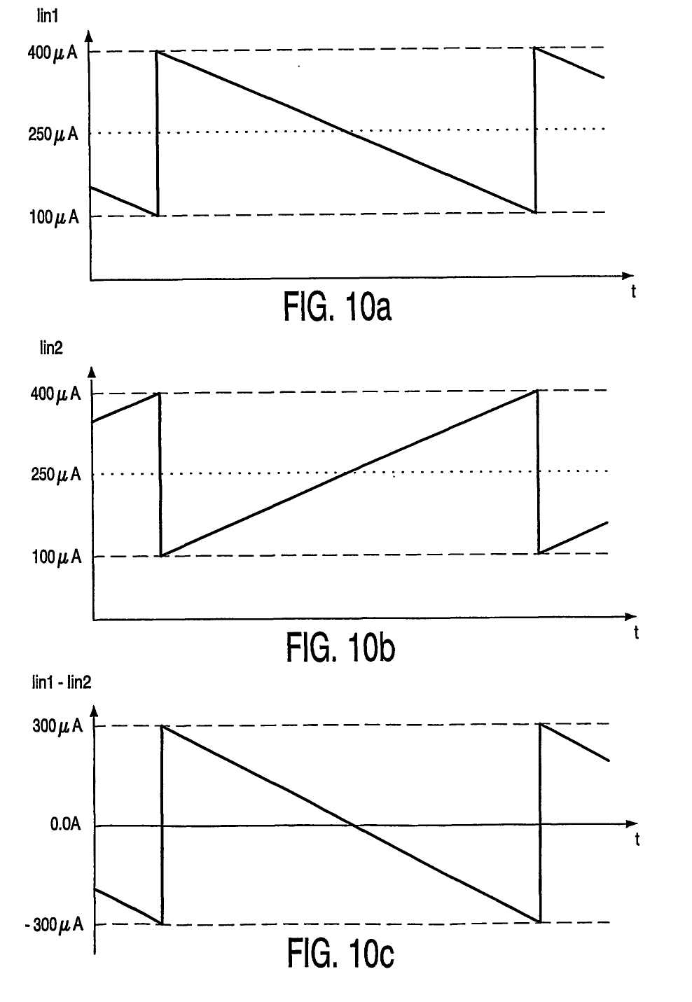

FIG. 10 shows in the part FIGS. 10a) to 10c) the input currents of a vertical booster with example values. The normal operation areas of the sawtooth function are:

For FIG. 10a): Possible signal (Iin1) for the positive input of a differential input device: Iin1=0.0 μA to +500 μA

For FIG. 10b): Possible signal (Iin2) for the negative input of a differential input device: Iin2=0.0 μA to +500 μA

For FIG. 10c): Differential input current range for Iin1−Iin2=−500 μA to +500 μA

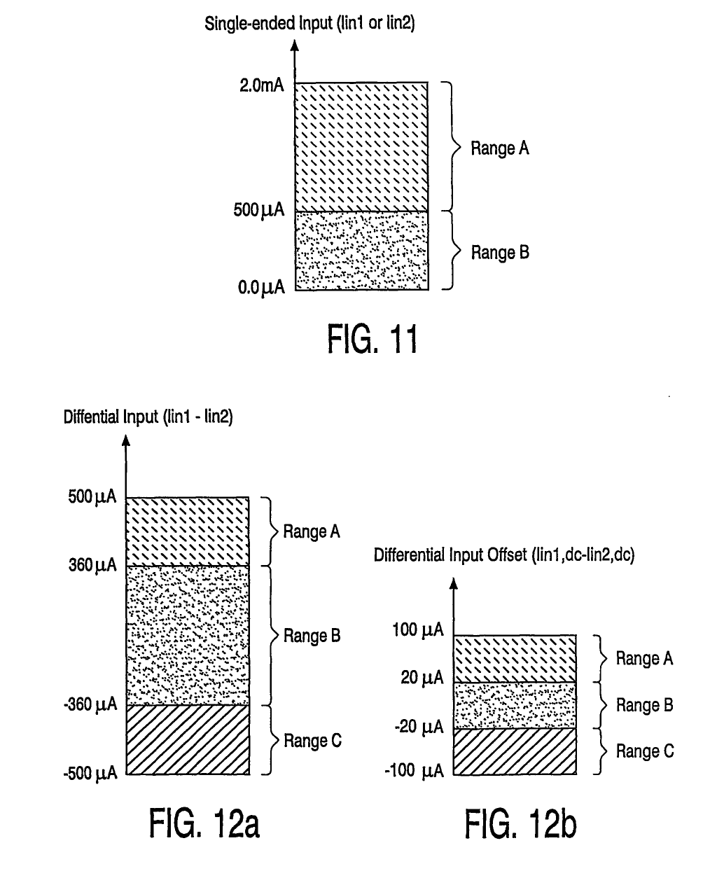

FIG. 11 shows a possible range definition for positive and negative inputs before mathematical operation. It is the example of a single-ended input range definition by sensing current. As defined above the normal input current range corresponds to the one described as range B. In this example the extended range goes up to 2.0 mA defined as range A. For a single-ended input (Iin1 or Iin2) the detection of the range is easy as only the input value has to be measured.

FIG. 12 shows in its part Figures examples of differential input range definition by sensing current. FIG. 12a) is a possible range definition of a signal in a differential input device and is derived from FIG. 10c) with consideration of the offset of ±20 μA and a tolerance. In this example the normal operating range is range B and the extended ranges are range A that goes from 360 μA to 500 μA and range C that goes from −360 μA to −500 μA. FIG. 12b) is a possible range definition of a signal in a differential input device after filtering out the alternating current signal and shows the rectified differential input Offset leaving out the sawtooths of FIG. 10c). This leads to saving power in the driver stage.

Differential Input Current Offset (Iin1, DC-Iin2, DC) range=0.0 μA to +20 μA

FIG. 13 shows an example of a truth table of mode selection for a vertical booster with single-ended detection. The possible detective ranges are A and B as shown in FIG. 11. In this example, B stands for the normal operating range. As soon as one of the inputs Iin1 or Iin2 is within the range A the standby mode for low power dissipation is activated. If at least one of the two inputs is out of the specified range, the standby mode is activated.

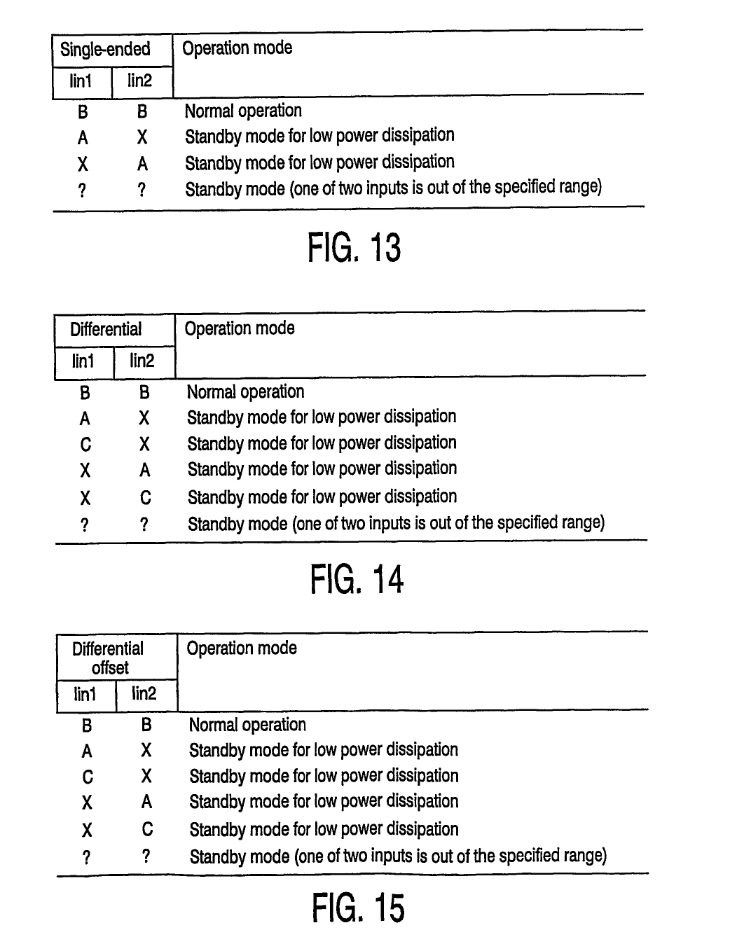

FIG. 14 shows an example of a truth table for the mode selection of a vertical booster with differential detection as shown in FIG. 12a). Letter X stands for either mode. If both inputs Iin1 and Iin2 are within the range B, the system is in the normal operation mode. If Iin1 and Iin2 are not both within the range B but are both within the extended range, the standby mode for low power dissipation is activated by the output stage. If one of the two inputs is out of the specified range, the standby mode is activated.

FIG. 15 shows an example of a truth table for the mode selection of a vertical booster with differential offset detection. The combinations of Iin1 and Iin2 and the operation mode are the same as in FIG. 14.

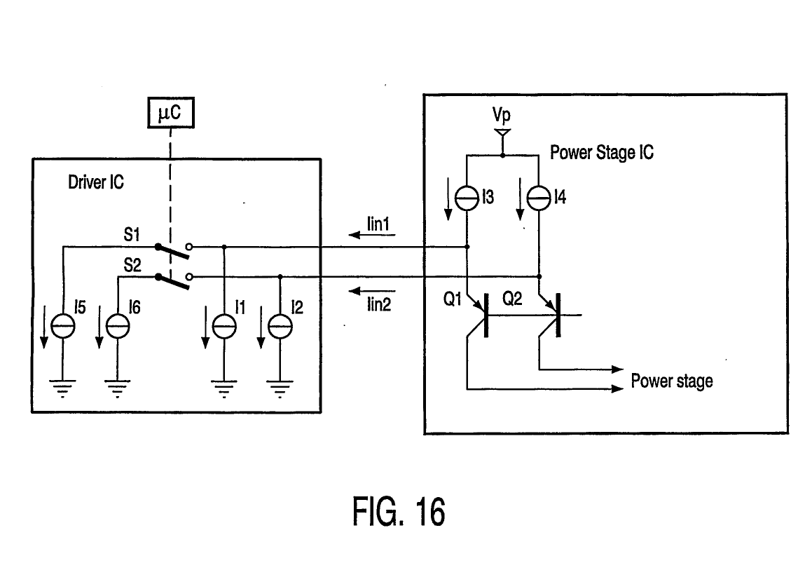

FIG. 16 shows the implementation of a differential input detection as mode selector. In this example the following values are used:
I1 and I2 carry the signal for normal operation range and are the drive current sources (+/−300 μA).
I5 and I6 are controlled current sources (approximately 1500 μA) that force the vertical booster in standby mode (low dissipation). They are switched on by the microcontroller under certain conditions.
S1 and S2 act as standby switches and are switched simultaneously by a microcontroller μC. When the switches S1 and S2 are shut extra current is drawn from the output stage and as consequence the power stage consumes less power.
I3 and I4 are sources (+/−800 μA) that bias input stage of the vertical booster.

The switches S1 and S2 set the input signals I1 and I2 to range A. If extra current is drawn from the power output stage, the power dissipation is minimum, only the quiescent current in the power stage remains. An extra detector circuit (for range A of FIG. 11) can be added to minimize the quiescent current in the output stage.

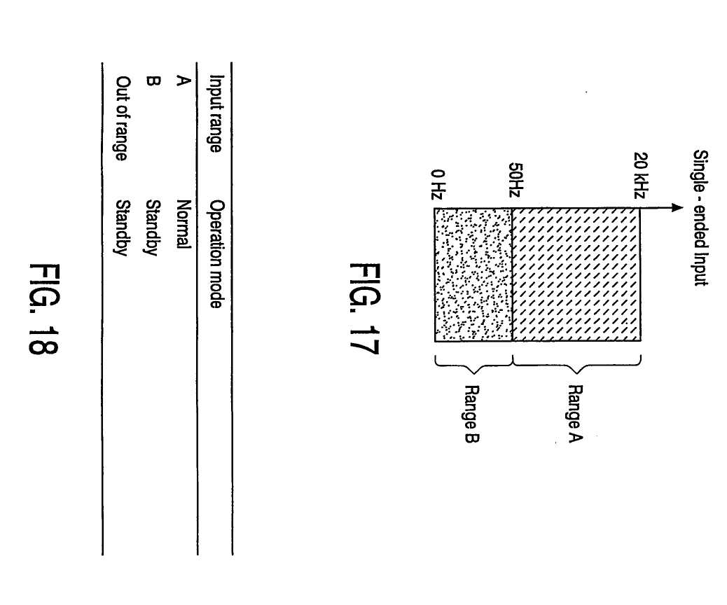

FIG. 17 shows a single-ended input range definition by sensing frequency. This is for example used in an audio power stage IC. In this example the range A goes from 50 Hz to 20 kHz, the range B goes from 0 to 50 Hz.

FIG. 18 shows an example of a truth-table for the mode selection with a frequency range example. In this example range A is defined as a normal operating mode and range B for the standby mode. If the input range is out of the specified range that is activated is as well the standby mode.

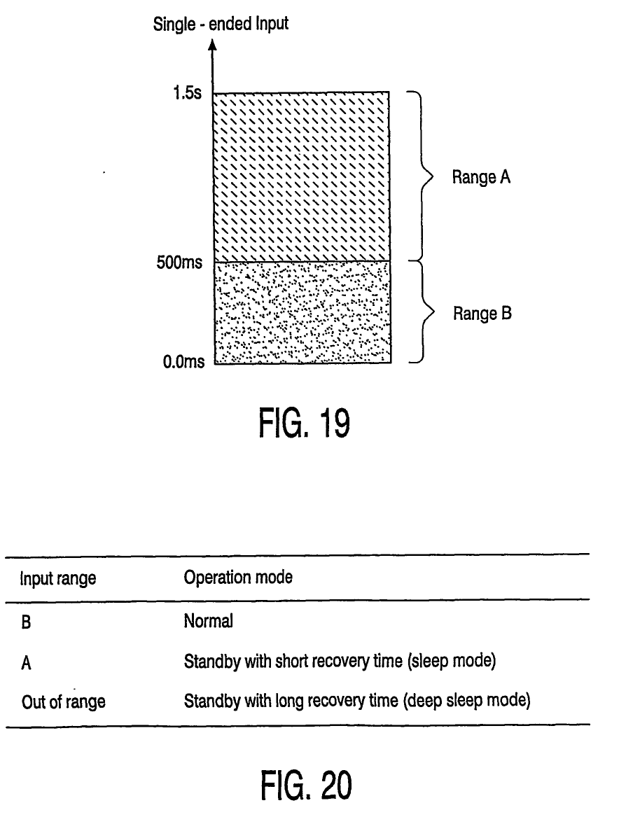

FIG. 19 shows a single-ended input range definition by sensing time. This is for example used as a digital IC with two standby modes. In this example range A goes from 500 ms to 1.5 s and range B goes from 0 to 500 ms. In this example range B is the normal operating range and range A the extended one.

FIG. 20 shows the truth table for a mode selection for time range example. If the input is in range B, the system is in the normal operation mode. If the input is in range A, the standby mode with short recovery time (sleep mode) is activated. If the input range is out of the specified range, the standby mode with long recovery time (deep sleep mode) is activated.

For all the embodiments has to be taken into account that a hysteresis appears when switching from one range to another. The amount of hysteresis is depending on the accuracy of the range detector.

The invention is derived from the perception that the traditional signal input of an output stage can also be used as input for setting the mode in that particular device. When driving a device with traditional input signals the device is in the normal operation mode. When driving a device with a signal level that lies above or under the specified input range the device is designed to recognize this special input level and enters a new (extended) mode.

### DESCRIPTION OF PREFERRED EMBODIMENTS

The preferred method for controlling the mode of an electronic application detects the range by measuring the value of a single-ended input.

The preferred circuitry that implements one of the claimed methods has an input signal that is generated by a current source and parallel to the first current source a second current source that is mounted as a reference with an “add current” switch connecting them.

1. Circuitry for an electronic application which
has at least a normal operation mode and at least one other mode,
comprises a power output stage IC and
has one or two inputs for the signal transferring concerning the normal operation mode, characterized in that the circuitry is further adapted to control the mode of the electronic application.

2. Circuitry as claimed in claim 1, characterized in that the input signal is generated by a current source whose one end is connected with a conjunction via a break contact and that this conjunction is also connected to a first reference current source via a first switch and to a second reference current source via a second switch.

3. Method for controlling the mode of an electronic application which has a normal operation mode and at least one other mode, characterized by using the connection(s) for the signal transfer concerning the normal operation mode also for the transfer of at least one signal concerning at least one other mode.

4. Method as set forth in claim 3, characterized in that a power output stage is part of the electronic application and adjusts the mode depending on its input value.

5. Method as set forth in claim 3, characterized in that the input signal of the output stage has a normal operation range and adjacent to that an extended range.

6. Method as set forth in claim 3, characterized in that the input signal is a current.

7. Method as set forth in claim 3, characterized in that the ranges for the normal operation mode and for the other modes are of different levels.

8. Method as set forth in claim 3, characterized in that the all over input value is divided in a number of “n” defined ranges.

9. Method as set forth in claim 3, characterized in that the range is detected by measuring the difference between two input values.

10. Method as set forth in claim 3, characterized in that the range is detected by measuring the value of a single-ended input.

11. Method as set forth in claim 3, characterized in that the input signal of the output stage enters a split that is adapted to determine whether the signal is within the normal operation range or within the extended range.

12. Method as set forth in claim 3, characterized in that a measured input value that is out of the extended range leads to an out of range info.

13. Method as set forth in claim 3, characterized in that the electronic application is driven in the normal operation mode when all input signals are within the normal operation range.

14. Method as set forth in claim 3, characterized in that the electronic application is a video booster and that adjacent to the normal operation range is above the level of normal operation range an extended range and that the combination of signal inputs where all inputs are within the normal operation range besides one and that this other input signal is within the extended range at least one of the colors of the booster is ultrablack.

15. Method as set forth in claim 3, characterized in that the electronic application is a video booster and that all booster outputs are ultrablack when none of the signal inputs is within the normal operation range.

16. Method as set forth in claim 3, characterized in that the input signal (Iin1 and/or Iin2) is a sawtooth function.

17. Method as set forth in claim 9, characterized in that the electronic application is changed into the standby mode for low power dissipation as soon as one of the detected ranges is not within the normal operation range.

18. Method as set forth in claim 3, characterized in that the output stage goes to a standby mode as soon as the input signal is out of the normal operation range.

19. Method as set forth in claim 3, characterized in that a normal input range leads to a normal operation mode, an extended input range leads to a standby mode with short recovery time (sleep mode) and an input range that is out of the normal or the extended range leads to a standby mode with low recovery time (deep sleep mode).
